(19) United States
(12) Patent Application Publication
(10) Pub. No.: US 2026/0330189 A1
(43) Pub. Date: Oct. 22, 2026

(54) ELECTRONIC DEVICE FOR FORECASTING WIRELESS CHANNEL FEATURES AND METHOD THEREOF

(71) Applicant: SAMSUNG ELECTRONICS CO., LTD., Suwon-si (KR)

(72) Inventors: Jongho OH, Suwon-si (KR); Wonjun HWANG, Suwon-si (KR); Jongjin PARK, Suwon-si (KR); Bongjin KIM, Suwon-si (KR)

(73) Assignee: SAMSUNG ELECTRONICS CO., LTD., Suwon-si (KR)

(21) Appl. No.: 19/533,991

(22) Filed: Feb. 9, 2026

Related U.S. Application Data
(63) Continuation of application No. PCT/KR2026/001476, filed on Jan. 26, 2026.

(30) Foreign Application Priority Data
Apr. 16, 2025 (KR) 10-2025-0049248
May 21, 2025 (KR) 10-2025-0066260

(51) Int. Cl. G06N 3/0455

(52) U.S. Cl. CPC G06N 3/0455

(57) ABSTRACT

An electronic device includes: communication circuitry; at least one processor; and memory storing instructions, wherein the instructions, when executed by the at least one processor individually or collectively, cause the electronic device to: receive reference signals through the communication circuitry, based on the reference signals, generate at least two latent representation sequences representing at least two different channel features, wherein each latent representation sequence of the at least two latent representation sequences comprises a plurality of latent representation indices representing a corresponding channel feature of the at least two different channel features, and output, through a latent transformer configured to obtain relationships between the at least two latent representation sequences, first forecasted data and second forecasted data, the first forecasted data representing future channel features corresponding to a first type of channel feature and the second forecasted data representing future channel features corresponding to a second type of channel feature.

### CROSS-REFERENCE TO RELATED APPLICATIONS

This application is a continuation of International Application No. PCT/KR2026/001476, filed on Jan. 26, 2026, which is based on and claims priority to Korean Patent Application Nos. 10-2025-0049248, filed on Apr. 16, 2025, and 10-2025-0066260, filed on May 21, 2025 in the Korean Patent Office, the disclosures of which are incorporated by reference herein in their entireties.

### BACKGROUND

### 1. Field

The disclosure relates to an electronic device and method for forecasting wireless channel features.

### 2. Description of Related Art

Fifth generation (5G) mobile communication technology defines a wide frequency band to enable fast transmission speeds and new services. 5G technology may be implemented not only in sub 6 GHz frequency bands such as 3.5 gigahertz (3.5 GHz) but also in millimeter wave (mmWave) ultra-high frequency bands (‘above 6 GHz’) such as 28 GHz and 39 GHz. Further, for 6G mobile communication technology, which is called a beyond 5G system, implementation in the terahertz band (e.g., the 95 GHz to 3 terahertz (3 THz) band) is being considered to achieve transmission speeds 50 times faster and with ultra-low latency reduced to one-tenth compared to 5G mobile communication technology.

In the early stages of 5G mobile communication technology, targeting service support and performance requirement satisfaction for enhanced mobile broadband (eMBB), ultra-reliable low-latency communications (URLLC), and massive machine-type communications (mMTC), standardization has progressed for beamforming and massive multiple-input multiple-output (MIMO). The progression has mitigated path loss and increased transmission distance of radio waves in ultra-high frequency bands, various numerology support for efficient utilization of ultra-high frequency resources (e.g., operating multiple subcarrier spacings) and dynamic operation of slot formats, initial access technologies to support multi-beam transmission and broadband, definition and operation of bandwidth parts (BWP), new channel coding methods such as low density parity check (LDPC) codes for large data transmission and polar codes for reliable transmission of control information, L2 pre-processing, or network slicing that provides dedicated networks specialized for specific services.

Various technologies utilizing artificial intelligence (AI) are being researched in wireless communication systems using next-generation wireless communication technology. The accuracy of AI technology based on deep learning is being dramatically enhanced, and research on applying AI technology in various fields is being conducted actively.

The background technology described above is technical information that the inventor possessed for deriving the disclosure or acquired in the process of deriving the disclosure and therefore cannot necessarily be considered as prior art publicly disclosed before the filing of the disclosure.

### SUMMARY

Embodiments of the disclosure may provide an electronic device and method for forecasting wireless channel features using artificial intelligence (AI).

Embodiments of the disclosure may provide an electronic device and method for forecasting future channel features based on correlations between wireless channel features.

According to an aspect of the disclosure, an electronic device includes: communication circuitry; at least one processor; and memory storing instructions, wherein the instructions, when executed by the at least one processor individually or collectively, cause the electronic device to: receive reference signals through the communication circuitry, based on the reference signals, generate at least two latent representation sequences representing at least two different channel features, wherein each latent representation sequence of the at least two latent representation sequences comprises a plurality of latent representation indices representing a corresponding channel feature of the at least two different channel features, and output, through a latent transformer configured to obtain relationships between the at least two latent representation sequences, first forecasted data and second forecasted data, the first forecasted data representing future channel features corresponding to a first type of channel feature and the second forecasted data representing future channel features corresponding to a second type of channel feature.

According to an aspect of the disclosure, a method performed by an electronic device, includes: receiving reference signals through a wireless channel; generating at least two latent representation sequences representing at least two different channel features based on the received reference signals, wherein each latent representation sequence of the at least two latent representation sequences comprises a plurality of latent representation indices representing a corresponding channel feature of the at least two different channel features; and outputting, through a latent transformer configured to obtain relationships between the at least two latent representation sequences, first forecasted data and second forecasted data, the first forecasted data representing future channel features corresponding to a first type of channel feature and the second forecasted data representing future channel features corresponding to a second type of channel feature.

Aspects of the disclosure are not limited to the foregoing, and other unmentioned aspects will be apparent to one of ordinary skill in the art from the following description.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment according to various embodiments.

FIG. 2 is a view illustrating a wireless communication system according to an embodiment of the disclosure.

FIG. 3 is a view illustrating channel feature measurement according to an embodiment of the disclosure.

FIG. 4 is a sequence diagram illustrating a procedure of channel estimation according to an embodiment of the disclosure.

FIG. 5 is a flowchart illustrating a procedure for forecasting channel features according to an embodiment of the disclosure.

FIG. 6 is a view illustrating a configuration of a latent transformer model for channel forecasting according to an embodiment of the disclosure.

FIG. 7 illustrates a configuration of transformer input sequences according to an embodiment of the disclosure.

FIG. 8 illustrates an example of values of transformer input sequences according to an embodiment of the disclosure.

FIG. 9 is a view illustrating an AI model including a latent transformer according to an embodiment of the disclosure.

FIG. 10 is a view illustrating an encoder architecture of a latent transformer according to an embodiment of the disclosure.

### DETAILED DESCRIPTION

Hereinafter, embodiments of the disclosure are described with reference to the accompanying drawings. When determined to make the subject matter of the disclosure unclear, the detailed description of the related functions or configurations in the embodiments of the disclosure may be skipped. The terms described below are defined considering the functions in embodiments of the present disclosure and may be replaced with other terms according to the intention or practice of the user or operator. Therefore, the terms should be defined based on the overall disclosure.

The terms as used herein are provided merely to describe an embodiment thereof, but not to limit the disclosure. The terms as used herein are provided merely to describe some embodiments thereof, but not to limit the scope of other embodiments of the present disclosure. Unless otherwise defined, all terms including technical and scientific terms used herein have the same meaning as commonly understood by one of ordinary skill in the art to which the embodiments of the disclosure pertain and should not be interpreted as overly broad or narrow. Alternatively, the technical terms used in the disclosure may be replaced with other technical terms understandable to one of ordinary skill in the art. General terms as used herein should be interpreted in the context of the specification or as defined in dictionaries.

As used herein, the singular forms “a,” “an,” and “the” may include the plural forms as well, unless the context clearly indicates otherwise. As used herein, the term “comprise” or “include” should not be interpreted as necessarily including all of several components or operations set forth herein but should rather be interpreted as omitting some components or operations or adding more components or operations.

As used herein, the terms “first” and “second” may be used to describe various components, but the components should not be limited by the terms. The terms may be used to distinguish one component from another. For example, a first component may be denoted a second component, and vice versa without departing from the scope of the present disclosure.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is “directly connected to” or “directly coupled to” another component, no other intervening components may intervene therebetween.

Hereinafter, embodiments of the disclosure will be described in detail with reference to the accompanying drawings. The same reference denotations may be used to refer to the same or substantially the same elements throughout the specification and the drawings. No duplicate description of the same elements is given herein. When determined to make the subject matter of the disclosure unclear, the detailed description of the known art or functions may be skipped. The accompanying drawings are provided for an easier understanding of embodiments of the disclosure but the disclosure should not be limited thereby. It should be interpreted that the disclosure may encompasses all other changes, equivalents, or replacements of those shown in the drawings.

In the disclosure, embodiments are described by taking an electronic device as an example, but the electronic device may also be referred to as a terminal, mobile station, mobile equipment (ME), user equipment (UE), user terminal (UT), subscriber station (SS), wireless device, handheld device, or access terminal (AT). In embodiments of the disclosure, the electronic device may be, e.g., a device having communication functionality, such as a mobile phone, a personal digital assistant (PDA), a smart phone, a wireless modem, or a laptop computer.

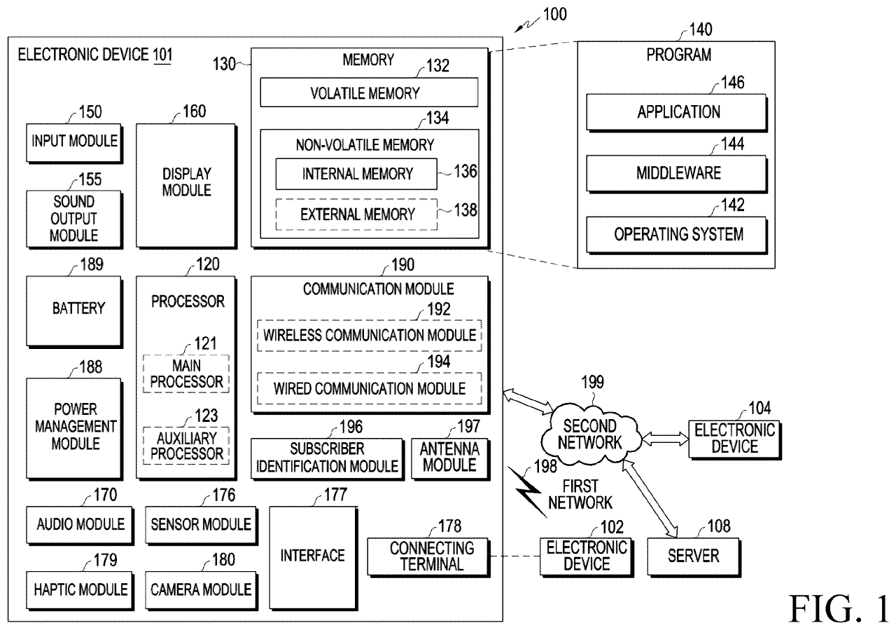

FIG. 1 is a block diagram illustrating an electronic device 101 in a network environment 100, according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

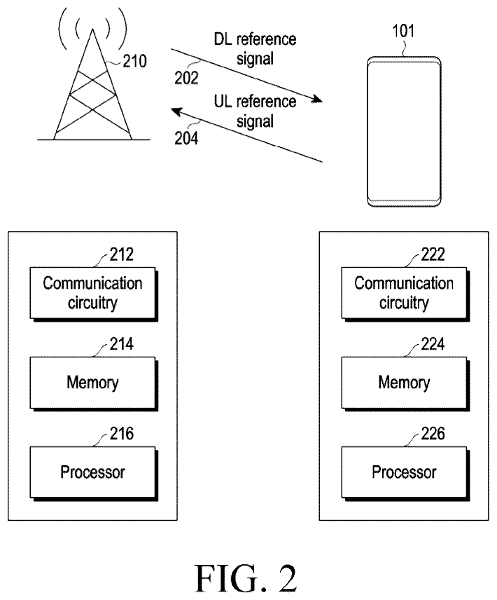

FIG. 2 is a view illustrating a wireless communication system according to an embodiment of the disclosure.

Referring to FIG. 2, a wireless communication system may include a base station 210 (e.g., node B, enhanced Node B (eNB), and/or new radio (NR) Node B (gNB)) and a user terminal 101 (e.g., the electronic device 101 of FIG. 1). The base station 210 and the electronic device 101 may communicate signals through physical channels.

The physical channels may correspond to a set of time/frequency resources used for transmission of a specific transport channel. The physical channels are divided into downlink (DL) channels and uplink (UL) channels. UL may refer to a wireless link through which the electronic device 101 transmits data and/or control signals (e.g., uplink control information) to the base station 210, and DL may refer to a wireless link through which the base station 210 transmits data and/or control signals (e.g., downlink control information) to the electronic device 101.

In a wireless communication system, wireless communication quality between the base station 210 and the electronic device 101 may depend on characteristics of a wireless channel. The wireless channel may be significantly affected by, for example, surrounding noise, interference signals, and fading. For the base station 210 and the electronic device 101 using a wireless channel environment, accurately estimating channel features may be a factor in determining communication performance. The base station 210 and the electronic device 101 performing wireless communication may estimate various channel features to enhance communication performance. In an embodiment, the base station 210 and the electronic device 101 may measure channel features, such as, signal to noise ratio (SNR), delay spread (DS), line of sight (LOS)/non-LOS (NLOS), beam, location, or doppler spread, but are not limited thereto and may further measure various channel features not mentioned in the disclosure.

In an embodiment, the base station 210 may transmit a downlink reference signal 202 including pre-agreed sequences through a downlink so that the electronic device 101 may estimate downlink channel features. The electronic device 101 may measure or estimate various channel features related to the downlink from the downlink reference signal 202.

In an embodiment, the electronic device 101 may transmit an uplink reference signal 204 including pre-agreed sequences through an uplink so that the base station 210 may estimate uplink channel features. The base station 210 may measure or estimate various channel features related to the uplink from the uplink reference signal 204.

In an embodiment, the base station 210 may include communication circuitry 212 (e.g., the wireless communication module 192), memory 214 (e.g., the memory 130), and a processor 216 (e.g., the processor 120 of FIG. 1 including at least one processing circuit). In some embodiments, the processor 216 may include one or more processors. In an embodiment, the memory 214 may store instructions, and the instructions, when executed by the processor 216 individually or collectively, may cause the base station 210 to perform operations (e.g., channel forecasting) according to embodiments of the disclosure.

In an embodiment, the electronic device 101 may include communication circuitry 222 (e.g., the wireless communication module 192), memory 224 (e.g., the memory 130), and a processor 226 (e.g., the processor 120 of FIG. 1 including at least one processing circuit). In some embodiments, the processor 226 may include one or more processors. In an embodiment, the memory 224 may store instructions, and the instructions, when executed by the processor 226 individually or collectively, may cause the electronic device 101 to perform operations (e.g., channel forecasting) according to embodiments of the disclosure.

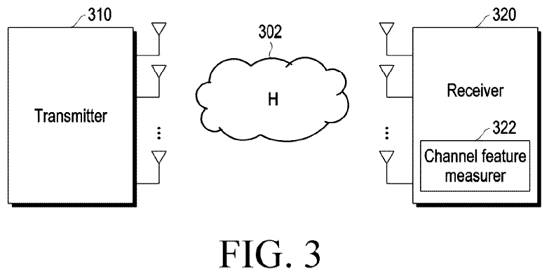

In some embodiments, for downlink communication, the base station 210 may operate as a transmitter (e.g., the transmitter 310 of FIG. 3) and the electronic device 101 may operate as a receiver (e.g., the receiver 320 of FIG. 3). In some embodiments, for uplink communication, the base station 210 may operate as a receiver (e.g., the receiver 320 of FIG. 3) and the electronic device 101 may operate as a transmitter (e.g., the transmitter 310 of FIG. 3).

FIG. 3 is a view illustrating a measurement of channel features according to an embodiment of the disclosure.

Referring to FIG. 3, a transmitted signal transmitted from a transmitter 310 (e.g., the base station 210 or the electronic device 101 of FIG. 2) may be received in the form of a received signal by a receiver 320 (e.g., the electronic device 101 or the base station 210 of FIG. 2) under the influence of a wireless channel H 302.

In an embodiment, the receiver 320 may use channel features to detect the transmitted signal from the received signal. In an embodiment, the receiver 320 may include a channel feature measurer 322. In an embodiment, the channel feature measurer 322 may measure channel features related to the wireless channel H 302 between the transmitter 310 and the receiver 320 using a known reference signal (e.g., the downlink reference signal 202 and/or the uplink reference signal 204) included in the transmitted signal. The measured channel features may be utilized for various purposes, such as, detecting the transmitted signal or scheduling. In an embodiment, the channel feature measurer 322 may be implemented in hardware, software, or a combination thereof.

In an embodiment, the channel feature measurer 322 may measure or forecast various channel features using AI technology. The AI technology may be based on deep learning. In a wireless communication system, channel features such as SNR, DS, or LOS/NLOS are closely related to each other, and these channel features may significantly affect system performance. For example, increasing SNR, reducing DS, and securing an LOS environment may enhance the performance of a wireless communication system. In an embodiment, the channel feature measurer 322 may forecast future channel features based on relationships between channel features.

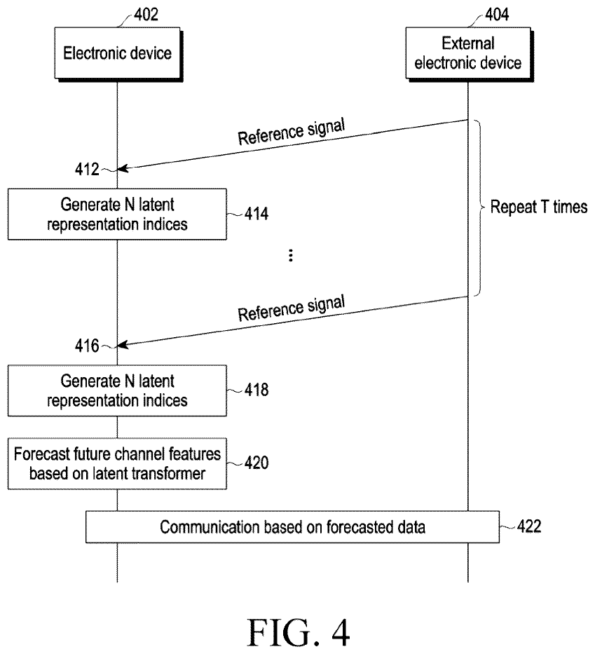

FIG. 4 is a sequence diagram illustrating a procedure for channel estimation according to an embodiment of the disclosure. Here, the procedure is illustrated where an electronic device 402 (e.g., the electronic device 101 or the base station 210 of FIG. 2) forecasts channel features for one external electronic device 404 (e.g., the base station 210 or the electronic device 101 of FIG. 2), but in some embodiments the electronic device 402 may perform the following operations to forecast channel features for one or more external electronic devices.

Referring to FIG. 4, in operation 412, the external electronic device 404 may transmit a reference signal (e.g., the downlink reference signal 202 or the uplink reference signal 204 of FIG. 2) including pre-agreed sequences to enable the electronic device 402 to forecast channel features. In operation 414, the electronic device 402 may analyze the reference signal to generate N latent representation indices respectively corresponding to N different channel features. In an embodiment, the N latent representation indices may include at least a first latent representation index corresponding to a first type of channel feature and a second latent representation index corresponding to a second type of channel feature. The first type of channel feature and the second type of channel feature being different. In an embodiment, the N latent representation indices may be generated by a latent transformer model.

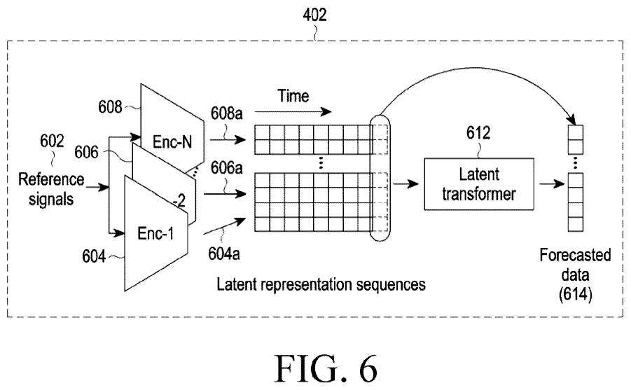

In some embodiments, in a transformer model, latent representation (i.e., latent space), may refer to a compressed form of input data that captures features (e.g., important features) of the input data. Through the latent space, the transformer model may learn relationships and patterns within the input data, and generate latent representation indices through an encoder (e.g., the encoders 604, 606, 608 of FIG. 6) that transforms the input data into a low-dimensional vector representation. The encoder may identify and extract relevant features from the input data and encode them into latent representations (e.g., latent representation indices).

In operation 416, the external electronic device 404 may transmit a reference signal (e.g., the downlink reference signal 202 or the uplink reference signal 204 of FIG. 2). The reference signal transmitted in operation 416 and the reference signal transmitted in operation 412 may be the same or different. In operation 418, the electronic device 402 may analyze the reference signal transmitted in the operation 416 to generate N latent representation indices respectively corresponding to N different channel features. In an embodiment, the electronic device 402 may repeat the operation of generating N latent representation indices (e.g., operation 414 or operation 418) a designated number of times (e.g., T) to generate N latent representation sequences of length T corresponding to different time-series channel features. In some embodiments, each latent representation sequence may include T latent representation indices.

In operation 420, the electronic device 402 may generate forecasted data representing future channel features corresponding to each channel feature based on correlations between a plurality of (e.g., N) latent representation indices corresponding to different channel features. In an embodiment, the forecasted data may include at least first forecasted data corresponding to a first type of channel feature and second forecasted data corresponding to a second type of channel feature. The first type of channel feature and the second type of channel feature may be different. In an embodiment, the electronic device 402 may generate first forecasted data representing future channel features corresponding to a first type of channel feature and second forecasted data representing future channel features corresponding to a second type of channel feature. In an embodiment, the forecasted data may include at least one of forecasted SNR data, forecasted DS data, or forecasted LOS/NLOS data.

In operation 422, the forecasted data may be used to enhance communication performance between the electronic device 402 and the external electronic device 404. In an embodiment, the electronic device 402 may perform scheduling for the external electronic device 404 based on the forecasted data, transmit the forecasted data to the external electronic device 404, and/or report the forecasted data to a server or a core network.

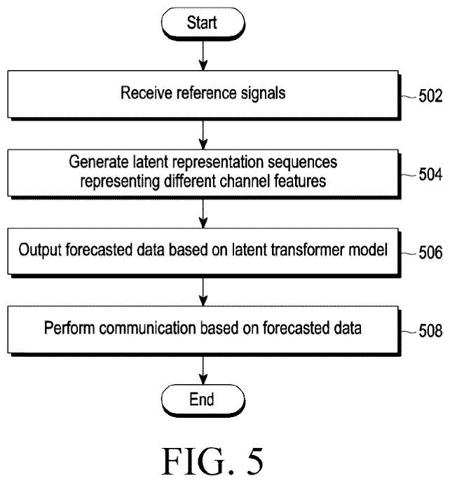

FIG. 5 is a flowchart illustrating a procedure for forecasting channel features according to an embodiment of the disclosure. At least one of the operations described below may be omitted, modified, or executed in a different order according to embodiments. In an embodiment, at least one of the operations described below may be executed by a processor (e.g., the processor 216 or the processor 226 of FIG. 2) of the electronic device 402 (e.g., the base station 210 or the electronic device 101 of FIG. 2). In an embodiment, memory (e.g., the memory 214 or the memory 224 of FIG. 2) of the electronic device 402 may store instructions that, when executed by the processor 216 or the processor 226 individually or collectively, cause the electronic device 402 to perform at least one of the operations described below.

Referring to FIG. 5, in operation 502, the electronic device 402 may receive reference signals (e.g., the downlink reference signal 202 or the uplink reference signal 204 of FIG. 2) including a pre-agreed sequence from an external electronic device (e.g., the external electronic device 404 of FIG. 4). In operation 504, the electronic device 402 may generate at least two latent representation sequences representing at least two different types of channel features based on the reference signals. In an embodiment, the at least two latent representation sequences may include at least one of a first latent representation sequence representing SNR, a second latent representation sequence representing DS, or a third latent representation sequence representing LOS/NLOS. In an embodiment, each latent representation sequence may include a plurality of (e.g., T) latent representation indices representing the corresponding channel feature. In an embodiment, the electronic device 402 may generate T latent representation indices by repeating the operation of receiving reference signals and measuring channel features T times.

In operation 506, the electronic device 402 may generate forecasted data representing future channel features corresponding to each channel feature based on a latent transformer model that obtains relationships between the at least two latent representation sequences. In an embodiment, the forecasted data may include at least first forecasted data representing future channel features corresponding to a first type of channel feature and second forecasted data representing future channel features corresponding to a second type of channel feature. The first type of channel feature and the second type of channel feature may be different. In an embodiment, the forecasted data may be used for the electronic device 402 to perform communication with the external electronic device 404.

In operation 508, the electronic device 402 may perform communication with the external electronic device 404 based on the forecasted data.

FIG. 6 is a view illustrating a configuration of a latent transformer model for channel forecasting according to an embodiment of the disclosure.

Referring to FIG. 6, the electronic device 402 may include a plurality of encoders 604, 606, 608 and a latent transformer 612. In an embodiment, the electronic device 402 may be configured to store instructions that represent or execute an AI model including the plurality of encoders 604, 606, 608 and the latent transformer 612 in memory (e.g., the memory 214 or 224 of FIG. 2), and/or execute the AI model by a processor (e.g., the processor 216 or 226 of FIG. 2).

In an embodiment, the plurality of encoders 604, 606, 608 may operate as channel feature generators (e.g., channel feature measurers) that receive the received reference signals 602 (e.g., the downlink reference signal 202 or the uplink reference signal 204 of FIG. 2) as input and output latent representation sequences 604a, 606a, 608a including latent representation indices corresponding to respective channel features. In an embodiment, a first encoder (Enc-1) 604 may generate a latent representation sequence 604a including latent representation indices representing a first type of channel feature (e.g., SNR). In an embodiment, a second encoder (Enc-2) 606 may generate a latent representation sequence 606a including latent representation indices representing a second type of channel feature (e.g., DS). In an embodiment, an Nth encoder (Enc-N) 608 may generate a latent representation sequence 608a including latent representation indices representing an Nth channel feature (e.g., LOS/NLOS). In an embodiment, the LOS/NLOS channel feature may include information (e.g., LOS probability and/or NLOS probability) indicating whether a wireless channel between the electronic device 402 and the external electronic device 404 is close to LOS or close to NLOS.

In an embodiment, the plurality of encoders 604, 606, 608 may be implemented using one or more AI models or may be implemented to utilize other signal processing methods. Since algorithms for measuring channel features through existing signal processing methods are well known to those skilled in the art, detailed descriptions may be omitted in the disclosure. As an example, the plurality of encoders 604, 606, 608 may determine each channel feature based on designated thresholds according to existing known algorithms.

In an embodiment, each latent representation sequence 604a, 606a, 608a may be used as input to the latent transformer 612, enabling the latent transformer 612 to forecast future channel features 614. The latent transformer 612 may utilize temporal correlations between latent representation sequences 604a, 606a, 608a representing multiple time-series channel features by applying scalability, and forecast channel features with higher accuracy through the temporal correlations between the latent representation sequences 604a, 606a, 608a.

In an embodiment, an AI model including the encoders 604, 606, 608 and the latent transformer 612 may be implemented as a neural processing unit (NPU) or graphic processing unit (GPU) included in a base station (e.g., the base station 210 of FIG. 2) or a user terminal (e.g., the electronic device 101 of FIG. 1), and may forecast various wireless channel features at once in real-time using received reference signals.

In an embodiment of the disclosure, the electronic device 402 may operate channel feature generators (e.g., the encoders 604, 606, 608) corresponding to N channel features from a reference signal received from an external electronic device (e.g., the external electronic device 404) to generate latent representation indices as shown in Equation 1 below.

L(f), f=1, . . . ,N Equation 1

Here, L(f) may represent a latent representation index corresponding to an f^{th} channel feature.

To track channel features that change over time, the electronic device 402 may repeat the operation of receiving a reference signal and generating N latent representation indices (e.g., operations 412 and 414) T times, and may obtain temporal latent representation sequences as shown in Equation 2 below. The plurality of (e.g., N) latent representation sequences may have the same dimension (e.g., T).

L(f,t), f=1, . . . ,N, t=1, . . . ,T Equation 2

Here, L(f,t) may represent a t^{th} latent representation index corresponding to an f^{th} channel feature. For example, an f^{th} latent representation sequence may be represented as {L(f,1), . . . , L(f,T)}.

In an embodiment, the plurality of (e.g., N) latent representation sequences (e.g., NT latent representation indices) may respectively correspond to a plurality of (e.g., N) different channel features and may be input to a latent transformer model (e.g., the latent transformer 612 of FIG. 6).

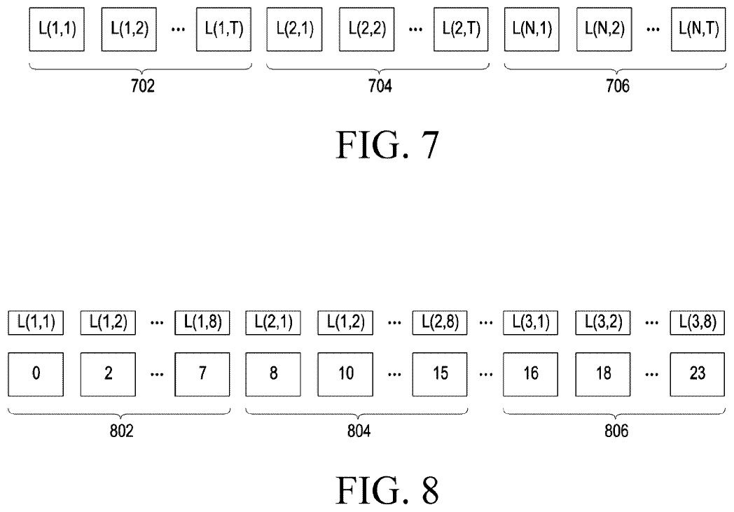

FIG. 7 illustrates a configuration of transformer input sequences according to an embodiment of the disclosure.

Referring to FIG. 7, a latent representation sequence 702 (e.g., the latent representation sequence 604a) corresponding to a first type of channel feature (e.g., SNR) may be {L(1,1), L(1,2), . . . , L(1,T)}, a latent representation sequence 704 (e.g., the latent representation sequence 606a) corresponding to a second type of channel feature (e.g., DS) may be {L(2,1), L(2,2), . . . , L(2,T)}, and a latent representation sequence 706 (e.g., the latent representation sequence 608a) corresponding to an Nth channel feature (e.g., LOS/NLOS) may be {L(N,1), L(N,2), . . . , L(N,T)}.

In an embodiment, the electronic device 402 (e.g., the latent transformer 612) may forecast N (or fewer than N) future latent representation indices through correlations between the plurality of latent representation sequences 702, 704, 706, and forecast future channel features from the future latent representation indices.

In an embodiment, the electronic device 402 may utilize channel models defined in the wireless communication system (e.g., rural macrocells (RMa), urban macrocells (UMa), or urban microcells (UMi), and/or utilize a clustered delay line (CDL) channel model or tapped delay line (TDL) channel model) to train an AI model including a plurality of encoders (e.g., the encoders 604, 606, 608) and the latent transformer 612. In some embodiments, the AI model may include one or more AI models. The electronic device 402 may perform inference on channel features in an actual communication environment based on an AI model including information learned in an offline environment based on the above-described channel models.

FIG. 8 illustrates an example of values of transformer input sequences according to an embodiment of the disclosure.

Referring to FIG. 8, the electronic device 402 may extract 3 (N=3) latent representation indices representing SNR, DS, and LOS/NLOS, respectively, through encoders (e.g., the encoders 604, 606, 608) at each iteration. During T iterations, the electronic device 402 may utilize 8 (T=8) past values for each channel feature and provide a total of 24 latent representation indices as input to the latent transformer 612.

In an embodiment, latent representation indices constituting a latent representation sequence corresponding to one channel feature may have values within a first range, and latent representation indices constituting a latent representation sequence corresponding to another channel feature may have values within a second range, and the second range may be continuous with the first range without overlapping.

In an embodiment, a latent representation sequence 802 corresponding to LOS/NLOS may be {L(1,1), L(1,2), . . . , L(1,8)}, a latent representation sequence 804 corresponding to DS may be {L(2,1), L(2,2), . . . , L(2,8)}, and a latent representation sequence 806 corresponding to SNR may be {L(3,1), L(3,2), . . . , L(3,8)}.

In an embodiment, each latent representation index may have a value between 0 and 23, where each latent representation index for LOS/NLOS may have a value between 0 and 7, each latent representation index for DS may have a value between 8 and 15, and each latent representation index for SNR may have a value between 16 and 23.

In an embodiment, the electronic device 402 may simultaneously consider all, or one or more, correlations between latent representation sequences corresponding to different channel features using the latent transformer 612, and flexibly reflect whether a latent representation sequence corresponding to a specific channel feature has a strong or weak correlation with a latent representation sequence corresponding to another channel feature through the correlations to forecast each future channel feature.

In an embodiment, the electronic device 402 may generate latent representation sequences corresponding to future channel features as output from the latent transformer 612, and forecast future channel features based on the latent representation sequences. In an embodiment, the electronic device 402 may generate a plurality of latent representation sequences corresponding to future channel features by setting a latent representation index corresponding to a future channel feature to an arbitrary value and inputting it to the latent transformer 612.

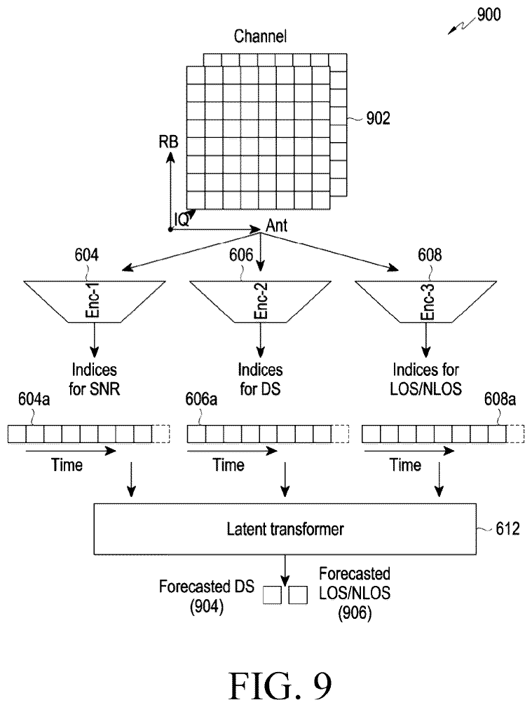

FIG. 9 is a view illustrating an AI model including a latent transformer according to an embodiment of the disclosure.

Referring to FIG. 9, an AI model 900 for channel forecasting may include a plurality of encoders 604, 606, 608 (e.g., the encoders 604, 606, 608 of FIG. 6) corresponding to different channel features and a latent transformer 612 (e.g., the latent transformer 612 of FIG. 6). In an embodiment, the encoders 604, 606, 608 may generate latent representation sequences 604a, 606a, 608a corresponding to each channel feature using channel data 902 corresponding to a received reference signal (e.g., the downlink reference signal 202 or the uplink reference signal 204) as input.

In an embodiment, the channel data 902 may include in-phase (I) signal components and quadrature-phase (Q) signal components obtained from the received reference signal, and each signal component may include signal values corresponding to a plurality of antennas and a plurality of resource blocks (RBs).

In an embodiment, the latent transformer 612 may output forecasted DS data 904 and forecasted LOS/NLOS data 906 using a latent representation sequence 604a for SNR, a latent representation sequence 606a for DS, and a latent representation sequence 608a for LOS/NLOS as inputs.

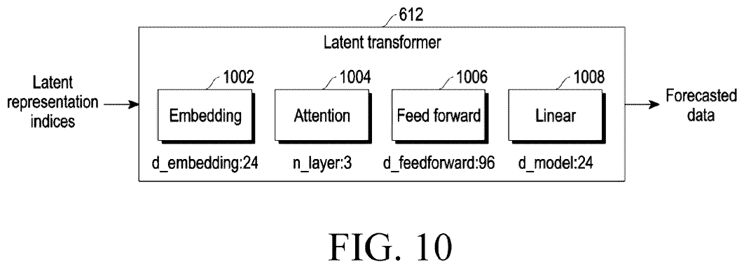

FIG. 10 is a view illustrating an encoder architecture of a latent transformer according to an embodiment of the disclosure.

Referring to FIG. 10, the latent transformer 612 may have a transformer encoder architecture composed of at least one of an embedding layer 1002, an attention layer 1004, a feed forward layer 1006, or at least one linear layer 1008.

In an embodiment, for channel feature forecasting based on 8 past values for 3 channel features, hyperparameters for controlling a learning process of the latent transformer 612 and determining values of model parameters ultimately learned by a learning algorithm may include at least one of the following.
n_seq=24
d_embedding=24
d_model=24
d_feedforward=96
n_layer=3
n_head=1

Here, n_seq may represent the total number of latent representation indices used as transformer input, d_embedding may represent an embedding dimension for the embedding layer 1002, d_model may represent a predetermined size of input and output in the latent transformer 612, d_feedforward may represent a hidden dimension in the feed forward layer 1006, n_layer may represent how many layers the encoder architecture in the latent transformer 612 is constituted of, and n_head may represent the number of heads of multi-head attention performed in the attention layer 1004.

In an embodiment, the latent transformer 612 includes the embedding layer 1002, the attention layer 1004, and the feed forward layer 1006, and may further include the linear layer 1008 according to a channel feature to be forecasted. In an embodiment, the latent transformer 612 may further include an activation function such as sigmoid according to a channel feature (e.g., LOS/NLOS) to be forecasted. In an embodiment, the latent transformer 612 may further include a positioning encoding layer between the embedding layer 1002 and the attention layer 1004.

In an embodiment, the embedding layer 1002 may have a dimension equal to d_model, and the attention layer 1004 and the feed forward layer 1006 may be constituted of n_layer layers. In an embodiment, the feed forward layer 1006 may have a hidden dimension equal to d_feedforward. In an embodiment, the linear layer 1008 may have a dimension of d_model. In an embodiment, one linear layer for LOS/NLOS and one linear layer for DS may be included in the linear layer 1008.

In an embodiment, the latent transformer 612 may apply an activation function (e.g., sigmoid function) to an output of the linear layer 1008 to obtain soft values between 0 and 1, and based on the soft values, forecast whether LOS/NLOS among future channel features is close to LOS or close to NLOS, and/or forecast whether DS is shorter or longer than a designated threshold, and generate forecasted data (e.g., the forecasted DS data 904 and/or the forecasted LOS/NLOS data 906) representing the forecasted result.

In an embodiment, the electronic device 402 may train an AI model including the encoders 604, 606, 608 and the latent transformer 612 based on RMa, UMa, and/or UMi channel models. As an example, when the electronic device 402 is a base station (e.g., the base station 210 of FIG. 2) and the external electronic device 404 is user equipment (UE) (e.g., the electronic device 101 of FIG. 2), the electronic device 402 may forecast LOS/NLOS features and DS features among future channel features for each user equipment using the trained AI model. In an embodiment, the electronic device 402 may receive reference signals (e.g., the uplink reference signal 204 of FIG. 2) periodically transmitted by a plurality of user equipment, perform inference on the received reference signals based on the trained AI model, and forecast LOS/NLOS and DS for each user equipment based on the inferred results.

Through embodiments of the disclosure, wireless channel features may be forecasted with high accuracy. The electronic device 402 based on an AI model trained according to embodiments of the disclosure may forecast LOS/NLOS channel features and DS channel features with an accuracy of 95% or higher regardless of SNR. Further, the electronic device 402 based on an AI model trained according to embodiments of the disclosure may further enhance communication performance by utilizing correlations between LOS/NLOS channel features and DS channel features.

An electronic device 402 according to an embodiment of the disclosure may include communication circuitry 212; 222, at least one processor 216; 226, and memory 214; 224 storing instructions. The instructions may, when executed by the at least one processor individually or collectively, cause the electronic device to receive reference signals through the communication circuitry, generate at least two latent representation sequences representing at least two different channel features based on the received reference signals, wherein each of the at least two latent representation sequences includes a plurality of latent representation indices representing the corresponding channel feature, and output at least first forecasted data representing future channel features corresponding to a first type of channel feature and second forecasted data representing future channel features corresponding to a second type of channel feature through a latent transformer configured to obtain relationships between the at least two latent representation sequences.

In an embodiment, each of the plurality of latent representation indices may indicate a plurality of time-series channel feature values.

In an embodiment, the at least two latent representation sequences may include at least a first latent representation sequence including first latent representation indices representing the first type of channel feature, and a second latent representation sequence including second latent representation indices representing the second type of channel feature. Each of the first latent representation indices may have a value within a first range, each of the second latent representation indices may have a value within a second range that is different from the first range, and the second range may be continuous with the first range.

In an embodiment, the latent transformer may include an embedding layer, an attention layer, a feed forward layer, and at least one linear layer.

In an embodiment, the at least one linear layer may include a first linear layer for forecasting LOS/NLOS channel features and a second linear layer for forecasting DS channel features.

In an embodiment, the instructions may, when executed by the at least one processor individually or collectively, cause the electronic device to generate a soft value indicating whether the LOS/NLOS channel features are close to LOS or close to NLOS by applying a sigmoid function to an output of the first linear layer.

In an embodiment, the instructions may, when executed by the at least one processor individually or collectively, cause the electronic device to apply a sigmoid function to each of an output of the first linear layer and an output of the second linear layer.

In an embodiment, at least one of the at least two channel features may include any one of signal to noise ratio (SNR), delay spread (DS), or line of sight (LOS)/non-LOS (NLOS).

In an embodiment, the latent transformer may be configured to forecast the future channel features based on information learned based on a rural macrocells (RMa) channel model, an urban macrocells (UMa) channel model, an urban microcells (UMi) channel model, a clustered delay line (CDL) channel model, and/or a tapped delay line (TDL) channel model.

In an embodiment, the instructions may, when executed by the at least one processor individually or collectively, cause the electronic device to generate the latent representation sequences by inputting channel data including in-phase (I) signal components and quadrature-phase (Q) signal components obtained from the received reference signals, and each of the I signal components and Q signal components may include signal values corresponding to a plurality of antennas and a plurality of resource blocks (RBs).

In a method performed by an electronic device 402 according to an embodiment of the disclosure, the method may include receiving (502) reference signals through a wireless channel, generating (504) at least two latent representation sequences representing at least two different channel features based on the received reference signals, wherein each of the at least two latent representation sequences includes a plurality of latent representation indices representing the corresponding channel feature, and outputting (506) at least first forecasted data representing future channel features corresponding to a first type of channel feature and second forecasted data representing future channel features corresponding to a second type of channel feature through a latent transformer configured to obtain relationships between the at least two latent representation sequences.

In an embodiment, each of the plurality of latent representation indices may indicate a plurality of time-series channel feature values.

In an embodiment, the at least two latent representation sequences may include at least a first latent representation sequence including first latent representation indices representing the first type of channel feature, and a second latent representation sequence including second latent representation indices representing the second type of channel feature. Each of the first latent representation indices may have a value within a first range, each of the second latent representation indices may have a value within a second range that is different from the first range, and the second range may be continuous with the first range.

In an embodiment, the latent transformer may include an embedding layer, an attention layer, a feed forward layer, and at least one linear layer.

In an embodiment, the at least one linear layer may include a first linear layer for forecasting LOS/NLOS channel features and a second linear layer for forecasting DS channel features.

In an embodiment, the method may further include generating a soft value indicating whether the LOS/NLOS channel features are close to LOS or close to NLOS by applying a sigmoid function to an output of the first linear layer.

In an embodiment, the method may further include applying a sigmoid function to each of an output of the first linear layer and an output of the second linear layer.

In an embodiment, at least one of the at least two channel features may include any one of signal to noise ratio (SNR), delay spread (DS), or line of sight (LOS)/non-LOS (NLOS).

In an embodiment, the latent transformer may be configured to forecast the future channel features based on information learned based on a rural macrocells (RMa) channel model, an urban macrocells (UMa) channel model, an urban microcells (UMi) channel model, a clustered delay line (CDL) channel model, and/or a tapped delay line (TDL) channel model.

In an embodiment, the method may further include generating the latent representation sequences by inputting channel data including in-phase (I) signal components and quadrature-phase (Q) signal components obtained from the received reference signals, and each of the I signal components and the Q signal components may include signal values corresponding to a plurality of antennas and a plurality of resource blocks (RBs).

In a non-transitory computer-readable storage medium storing one or more programs according to an embodiment of the disclosure, the one or more programs, when executed by at least one processor 216; 224 of an electronic device 402, may include instructions configured to cause the electronic device to receive reference signals, generate at least two latent representation sequences representing at least two different channel features based on the received reference signals, wherein each of the at least two latent representation sequences includes a plurality of latent representation indices representing the corresponding channel feature, and output at least first forecasted data representing future channel features corresponding to a first type of channel feature and second forecasted data representing future channel features corresponding to a second type of channel feature through a latent transformer configured to obtain relationships between the at least two latent representation sequences.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
communication circuitry;
at least one processor; and
memory storing instructions,
wherein the instructions, when executed by the at least one processor individually or collectively, cause the electronic device to:
receive reference signals through the communication circuitry,
based on the reference signals, generate at least two latent representation sequences representing at least two different channel features, wherein each latent representation sequence of the at least two latent representation sequences comprises a plurality of latent representation indices representing a corresponding channel feature of the at least two different channel features, and
output, through a latent transformer configured to obtain relationships between the at least two latent representation sequences, first forecasted data and second forecasted data, the first forecasted data representing future channel features corresponding to a first type of channel feature and the second forecasted data representing future channel features corresponding to a second type of channel feature.

2. The electronic device of claim 1, wherein each latent representation index of the plurality of latent representation indices indicates a plurality of time-series channel feature values.

3. The electronic device of claim 1, wherein the at least two latent representation sequences comprise:
a first latent representation sequence comprising first latent representation indices representing the first type of channel feature, and
a second latent representation sequence comprising second latent representation indices representing the second type of channel feature,
wherein each of the first latent representation indices has a value within a first range,
wherein each of the second latent representation indices has a value within a second range that is different from the first range, and
wherein the second range is continuous with the first range.

4. The electronic device of claim 1, wherein the latent transformer comprises an embedding layer, an attention layer, a feed forward layer, and at least one linear layer.

5. The electronic device of claim 4, wherein the at least one linear layer comprises:
a first linear layer for forecasting line of sight (LOS)/non-LOS (NLOS) channel features, and
a second linear layer for forecasting delay spread (DS) channel features.

6. The electronic device of claim 5, wherein the instructions, when executed by the at least one processor individually or collectively, cause the electronic device to:
generate a soft value by applying a sigmoid function to an output of the first linear layer, the soft value indicating whether the LOS/NLOS channel features are close to LOS or close to NLOS.

7. The electronic device of claim 5, wherein the instructions, when executed by the at least one processor individually or collectively, cause the electronic device to:
apply a sigmoid function to each of an output of the first linear layer and an output of the second linear layer.

8. The electronic device of claim 1, wherein at least one of the at least two different channel features comprises any one of signal to noise ratio (SNR), delay spread (DS), or line of sight (LOS)/non-LOS (NLOS).

9. The electronic device of claim 1, wherein the latent transformer is configured to forecast the future channel features based on information that is learned based on at least one of a rural macrocells (RMa) channel model, an urban macrocells (UMa) channel model, an urban microcells (UMi) channel model, a clustered delay line (CDL) channel model, or a tapped delay line (TDL) channel model.

10. The electronic device of claim 1, wherein the instructions, when executed by the at least one processor individually or collectively, cause the electronic device to:
generate the at least two latent representation sequences based on channel data comprising in-phase (I) signal components and quadrature-phase (Q) signal components obtained from the received reference signals, and
wherein each of the I signal components and the Q signal components comprises signal values corresponding to a plurality of antennas and a plurality of resource blocks (RBs).

11. A method performed by an electronic device, the method comprising:
receiving reference signals through a wireless channel;
generating at least two latent representation sequences representing at least two different channel features based on the received reference signals, wherein each latent representation sequence of the at least two latent representation sequences comprises a plurality of latent representation indices representing a corresponding channel feature of the at least two different channel features; and
outputting, through a latent transformer configured to obtain relationships between the at least two latent representation sequences, first forecasted data and second forecasted data, the first forecasted data representing future channel features corresponding to a first type of channel feature and the second forecasted data representing future channel features corresponding to a second type of channel feature.

12. The method of claim 11, wherein each latent representation index of the plurality of latent representation indices indicates a plurality of time-series channel feature values.

13. The method of claim 11, wherein the at least two latent representation sequences comprise:
a first latent representation sequence comprising first latent representation indices representing the first type of channel feature, and
a second latent representation sequence comprising second latent representation indices representing the second type of channel feature, and
wherein each of the first latent representation indices has a value within a first range,
wherein each of the second latent representation indices has a value within a second range that is different from the first range, and
wherein the second range is continuous with the first range.

14. The method of claim 11, wherein the latent transformer comprises an embedding layer, an attention layer, a feed forward layer, and at least one linear layer.

15. The method of claim 14, wherein the at least one linear layer comprises:
a first linear layer for forecasting line of sight (LOS)/non-LOS (NLOS) channel features, and
a second linear layer for forecasting delay spread (DS) channel features.

16. The method of claim 15, further comprising generating a soft value by applying a sigmoid function to an output of the first linear layer, the soft value indicating whether the LOS/NLOS channel features are close to LOS or close to NLOS.

17. The method of claim 15, further comprising applying a sigmoid function to each of an output of the first linear layer and an output of the second linear layer.

18. The method of claim 11, wherein at least one of the at least two different channel features comprises any one of signal to noise ratio (SNR), delay spread (DS), or line of sight (LOS)/non-LOS (NLOS).

19. The method of claim 11, wherein the latent transformer is configured to forecast the future channel features based on information that is learned based on at least one of a rural macrocells (RMa) channel model, an urban macrocells (UMa) channel model, an urban microcells (UMi) channel model, a clustered delay line (CDL) channel model, or a tapped delay line (TDL) channel model.

20. The method of claim 11, further comprising generating the at least two latent representation sequences by inputting channel data comprising in-phase (I) signal components and quadrature-phase (Q) signal components obtained from the received reference signals,
wherein each of the I signal components and the Q signal components comprises signal values corresponding to a plurality of antennas and a plurality of resource blocks (RBs).
